(19) United States
(12) Patent Application Publication
(10) Pub. No.: US 2008/0104714 A1
(43) Pub. Date: May 1, 2008

(54) Methods, Media, and Systems for Access Control to Content Distributions

(76) Inventors: Howard Singer, Morganville, NJ (US); George Lydecker, Burbank, CA (US); Anthony Thompson, Simi Valley, CA (US)

Correspondence Address: Matthew T. Byrne, 305 Broadway, 9th Floor, New York, NY, 10007, US

(21) Appl. No.: 11/877,856

(22) Filed: Oct. 24, 2007

Related U.S. Application Data
(60) Provisional application No. 60/853,998, filed on Oct. 24, 2006.
(60) Provisional application No. 60/926,609, filed on Apr. 26, 2007.

(51) Int. Cl. G06F 7/04

(52) U.S. Cl. 726/30

(57) ABSTRACT

Methods, media, and systems for access control to content distributions are provided. In some embodiments, methods for access control to a content distribution are provided, the methods comprising: detecting at least two of a subcode, a watermark, hidden bits, a wobble track, and a valid wobble track code in the content distribution; determining whether the content distribution is an authorized product based on the detecting; and performing an action based on whether the content distribution is determined to be an authorized product.

### CROSS-REFERENCE TO RELATED APPLICATIONS

This application claims the benefit of U.S. Provisional Patent Application No. 60/853,998, filed Oct. 24, 2006, and U.S. Provisional Patent Application No. 60/926,609, filed Apr. 26, 2007, which are hereby incorporated by reference herein in their entireties.

### FIELD OF TECHNOLOGY

The disclosed subject matter relates to methods, media, and systems for access control to content distributions.

### BACKGROUND

Standard recordings of audio content are currently typically issued on manufactured optical media. The audio content on these manufactured discs adheres to the IEC 980 standard, also known as the Sony Philips Red Book Standard, resulting in an article certified as a Compact Disc (CD). With the advent of ubiquitous computer technology, unauthorized digital reproduction of IEC 980 CD audio content became commonplace. Concurrently, audio compression schemes achieved wide-spread availability world-wide, resulting in the uncontrolled exchange of audio content across sprawling content transport networks commonly known as peer-to-peer systems, without regard for the copyright holder.

In many instances, unauthorized reproductions of audio content have been recorded onto content distributions, such as recordable Compact Discs (CDs) and Digital Video Discs (DVDs). Such content distributions then have been improperly used in the same or similar manners to authorized content distributions.

In attempts to re-establish genuine copyright holder audio content source control, various methods of protection were applied to optical media in order to circumvent the unauthorized digital reproduction of audio content. Many techniques, however, cause the manufactured disc to deviate from the IEC 980 CD specification, and therefore rely on incompatibility modes to preclude unauthorized digital reproduction.

For example, these CD incompatibility mode techniques range from altering the P-sub-code data in the media table of content, the intentional misdirection of the start address of the audio when using a software-based media player, and deviation from standard 98 frames per sector to a non-standard value (misdirecting the recovery of the audio signal with probable signal degradation), to invasive and intrusive technologies which compromise a consumer's computer platform. In all cases, these approaches compromise compatibility with standard consumer electronics (particularly mixed-media players), and in some cases have precluded reasonable fair-use with computer platforms using the consumer's choice of software-based players.

It is therefore desirable to provide mechanisms that provide access control for media.

### SUMMARY

Methods, media and systems for access control to content distributions are provided. In some embodiments, methods for access control to a content distribution are provided, the methods comprising: detecting at least two of a subcode, a watermark, hidden bits, a wobble track, and a valid wobble track code in the content distribution; determining whether the content distribution is an authorized product based on the detecting; and performing an action based on whether the content distribution is determined to be an authorized product.

In some embodiments, computer-readable media containing computer-executable instructions that, when executed by a processor, cause the processor to perform a method for access control to a content distribution are provided, the method comprising: detecting at least two of a subcode, a watermark, hidden bits, a wobble track, and a valid wobble track code in the content distribution; determining whether the content distribution is an authorized product based on the detecting; and performing an action based on whether the content distribution is determined to be an authorized product.

In some embodiments, systems for access control to a content distribution are provided, the systems comprising: a processor that: detects at least two of a subcode, a watermark, hidden bits, a wobble track, and a valid wobble track code in the content distribution; determines whether the content distribution is an authorized product based on the detecting; and performs an action based on whether the content distribution is determined to be an authorized product.

### BRIEF DESCRIPTION OF THE DRAWINGS

FIG. 1 is a block diagram of a system for applying rights management using subcodes in accordance with some embodiments.

FIG. 2 illustrates a table for actions that can be taken based on the presence or absence of subcodes and watermarks in accordance with some embodiments.

FIG. 3 is a block diagram of another system for applying rights management using a wobble track in accordance with some embodiments.

FIG. 4 illustrates a table for actions that can be taken based on the presence or absence of wobble tracks and watermarks in accordance with some embodiments.

FIG. 5 is a block diagram of a system for applying rights management that add watermarks in accordance with some embodiments.

FIG. 6 illustrates a table for actions that can be taken based on the presence or absence of subcodes and watermarks, including adding watermarks, in accordance with some embodiments.

FIG. 7 is a block diagram of a system for applying rights management that adds hidden bits in accordance with some embodiments.

FIG. 8 illustrates a table for actions that can be taken based on the presence or absence of subcodes and hidden bits, including adding hidden bits, in accordance with some embodiments.

FIGS. 9a and 9b are illustrations of a wobble track waveform with absences of wobble in accordance with some embodiments.

FIG. 10 is a diagram of a process for checking a wobble track code in accordance with some embodiments.

FIG. 11 is a block diagram of a system for applying watermarks to, and retrieving watermarks from, a content distribution in accordance with some embodiments.

FIG. 12 illustrates a mechanism for producing a content distribution in accordance with some embodiments.

FIG. 13 illustrates a data structure for a SubCode packet in accordance with some embodiments.

FIG. 14 illustrates P-W subcodes in accordance with some embodiments.

### DETAILED DESCRIPTION

The following description includes many specific details. The inclusion of such details is for the purpose of illustration only and should not be understood to limit the invention. Moreover, certain features, which are well known in the art, are not described in detail in order to avoid complication of the subject matter of the present invention. In addition, it will be understood that features in one embodiment may be combined with features in other embodiments of the invention.

In accordance with various embodiments of the present invention, methods, media, and systems for access control to content distributions are provided.

In some embodiments, it may be determined whether a content distribution is an authorized product or an unauthorized reproduction, and based on that determination different levels of access control may be granted. For example, a CD may be evaluated to determine if it is an original, manufactured CD or a burned recordable CD with unauthorized content. If the CD is determined to be the latter, usage of the CD may be restricted or prevented. If the CD is determined to be the former, full access to the content as well as additional benefits may be provided to the holder of the CD—for example, the holder may be entitled to receive additional materials (e.g., a bonus track) and/or be permitted to transfer content to another device (e.g., a mobile device).

Depending on whether a content distribution is determined to be authorized or unauthorized, any suitable level of access to the content distribution may be granted. For example, access controls may govern: whether and how content can be transferred into and used in an application (such as a media player); whether and how protection (such as digital rights management (DRM) may be applied to content; whether and how a watermark may be applied to content; whether and how hidden bits may be applied to content; whether and how content may be ripped to other media formats (e.g., ripping may be permitted at high quality or only low quality); whether and how addition benefits may be given; and/or any other suitable level(s) of access.

In some embodiments, various mechanisms can be used to determine whether a content distribution is authorized or unauthorized. For example, in some embodiments, subcodes, watermarks, hidden bits, and/or wobble tracks can be used to determine whether a content distribution is authorized or unauthorized. Further details oil some examples of this are described below.

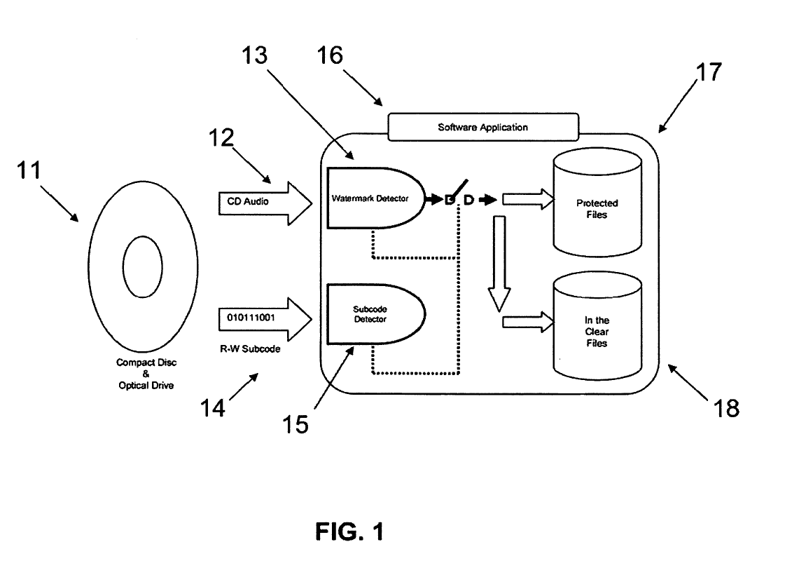

In accordance with some embodiments of the invention, a mechanism for decoding a content distribution may operate as illustrated in FIG. 1. As shown, a content distribution 11, such as a compact disc, may be read. As described in more detail below, audio content 12 (for example) and subcodes 14 may be provided as a result of reading content distribution 11. Audio 12 and subcodes 14 may then be processed by a software application 16, or any other suitable mechanism, such as dedicated hardware, a microprocessor executing firmware, etc. For example, in application 16, a watermark detector 13 may detect the watennarks in audio 12 and a subcode detector 15 may detect subcodes in subcodes 14. These detectors may then be used to determine whether the files are protected 17 or in-the-clear 18. This determination may be made as described below.

Although these embodiments and embodiments described herein are illustrated as being read from a compact disc in accordance with IEC 980, various embodiments could additionally or alternatively provide the ability to read from any other suitable forms of media, such as other types of compact discs, DVDs, high definition DVDs, BlueRay discs, etc., and from files, audio streaming, and audio cards (e.g., from a line-in from another source).

Upon receiving content 12, a watermark detector 13 may determine if a watermark is present in the content. Any suitable known technique for generating a watermark and determining whether a watermark is present in the content may be used.

Upon receiving subcodes 14, a subcode detector 15 may determine if certain subcodes are present on the content distribution. As described in more detail below, the certain subcodes may be present in subcodes R through W of a compact disc.

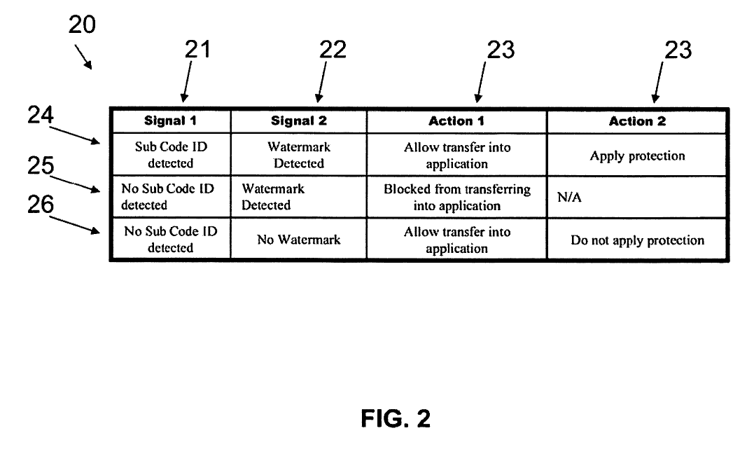

Depending on whether a watermark and/or the certain subcodes are detected, certain actions may be taken as illustrated as an example in table 20 of FIG. 2. As shown, the first two columns 21 and 22 indicate whether the certain subcodes (first column 21) or a watermark (second column 22) were detected. The second two columns 23 and 24 illustrate examples of what actions may be taken, for example, whether the content will be allowed to be transferred into an application (third column 23) and whether protection (e.g., digital rights management) will be applied to the content (fourth column 24).

As shown in row 25, if content contains a watermark and is accompanied by the certain subcodes, that content may be allowed to be transferred into an application such as: iTunes MusicStore, iTunes, and/or QuickTime Player from Apple Computer, Inc.; Zune MarketPlace and/or Windows Media Player from Microsoft Corporation; Rhapsody and/or Real Player from Real Networks, Inc.; Musicmatch Jukebox from Yahoo! Inc.; and/or any other suitable application(s)) as shown in the third column 23. As shown in the fourth column 24, this content may also be identified as copyrighted material, and as such may have digital rights management (DRM) applied. For example, this DRM may be the same or similar to that applied to content that is purchased online and may result in the content being converted to a different format and/or encrypted as suitable.

As shown in row 26, if a watermark is detected, but the certain subcodes are not detected, then content may be identified as being copyrighted material and the content distribution may be identified as not being a manufactured and purchased disc. Accordingly, transfer into the application may be prevented as shown in the third column 23. This may be the case, for example, when copyrighted audio content is read from a file, streaming media, an audio card, or any other input.

As shown in row 27, if no watermark is detected and the certain subcodes are not detected, then the content may be allowed to be transferred into the application (as shown in column 23) and no DRM may not be applied to the content (as shown in column 24). This may be the case, for example, when content that is not copyrighted, or is a personal performance of the user, is being read from the content distribution, and as such the protection scheme should not interfere with this class of content.

As described above, rather than controlling transfer of content into an application and applying protection as illustrated in FIG. 2, additional or alternative access control actions may be used. For example, the following access controls may be used: whether and how a watermark may be applied to content; whether and how hidden bits may be applied to content; whether and how content may be ripped to other media formats (e.g., ripping may be permitted at high quality or only low quality); whether and how addition benefits may be given; and/or any other suitable level(s) of access.

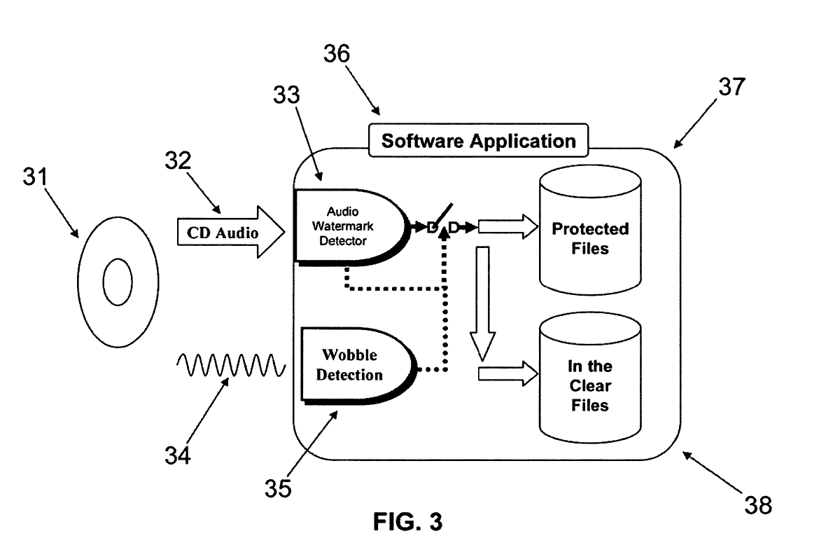

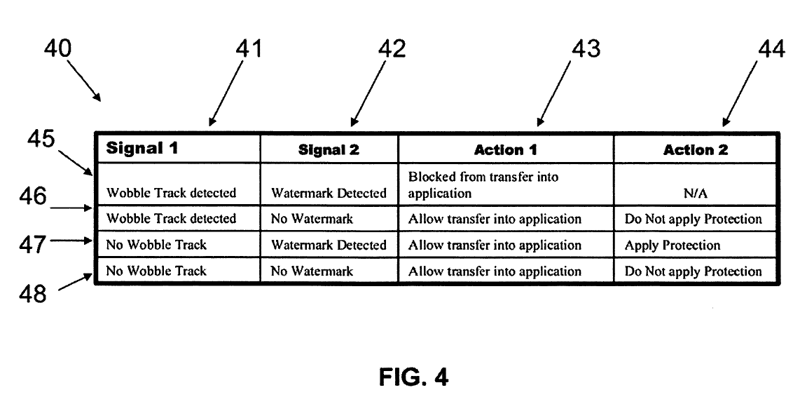

FIGS. 3 and 4 illustrate another approach that may be implemented in some embodiments.

As shown in FIG. 3, a content distribution 31, such as a compact disc, may be read. As described in more detail below, audio content 32 (for example) and a wobble track 34 may be provided as a result of reading content distribution 31. Audio 32 and wobble track 34 may then be processed by a software application 36, or any other suitable mechanism, such as dedicated hardware, a microprocessor executing firmware, etc. For example, in application 36, a watermark detector 33 may detect the watermarks in audio 32 and a wobble track detector 35 may detect wobble track 34. These detectors may then be used to determine whether the files are protected 37 or in-the-clear 38. This determination may be made as described below.

Thus, rather than detecting subcodes, a wobble detector can be used to detect whether a wobble signal is present in the content distribution. As is known in the art and described further below, many recordable compact discs have a wobble signal that is used to control operation of the disc. If this signal is detected, then it is known that the disc is not a pre-manufactured disc.

Based on whether the wobble track and/or watermark are detected, certain actions may be taken, for example, as described below and illustrated in table 40 of FIG. 4.

As shown in row 45, if a wobble track and a watermark are both detected, then the content may be blocked from being transferred into the application as shown in column 43.

As shown in row 46, if a wobble track is detected (as indicated in column 41), but no watermark is detected (as indicated in column 42), then the content may be allowed to be transferred into the application (as shown in column 43) and protection (such as, e.g., DRM) may not be applied (as shown in column 44).

As shown in row 47, if a wobble track is not detected and a watermark is detected, then the content may be allowed to be transferred into the application (as shown in column 43) and protection may be applied (as shown in column 44).

As shown in row 48, if neither a wobble track nor a watermark are detected, then the content may be allowed to be transferred into the application (as shown in column 43) and protection may not be applied (as shown in column 44).

As described above, rather than controlling transfer of content into an application and applying protection as illustrated in FIG. 4, additional or alternative access control actions may be used. For example, the following access controls may be used: whether and how a watermark may be applied to content; whether and how hidden bits may be applied to content; whether and how content may be ripped to other media formats (e.g., ripping may be permitted at high quality or only low quality); whether and how addition benefits may be given; and/or any other suitable level(s) of access.

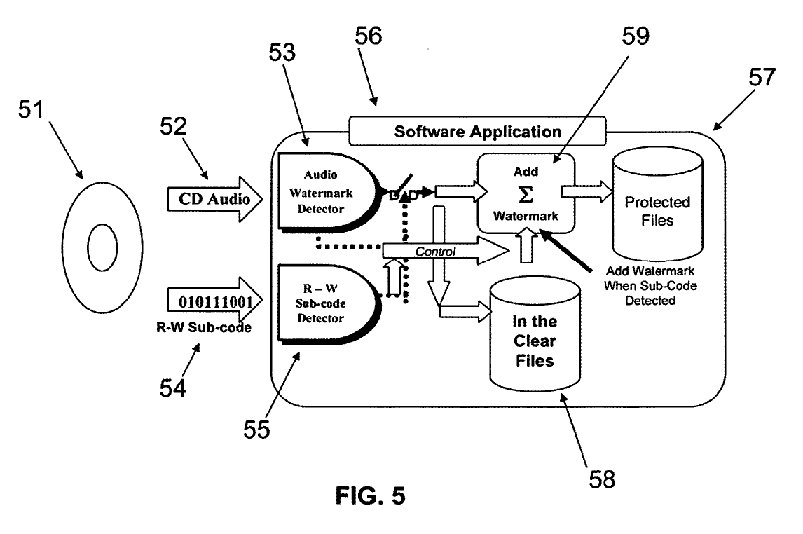

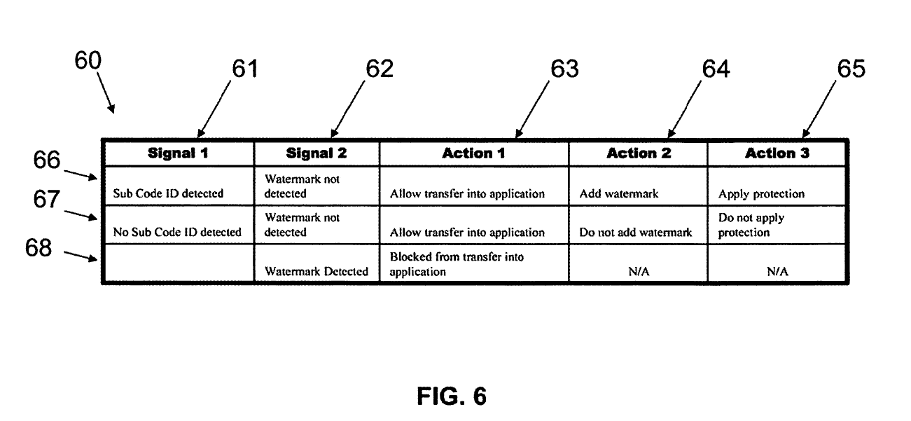

FIGS. 5 and 6 illustrate yet another approach that may be used in accordance with certain embodiments.

As shown in FIG. 5, a content distribution 51, such as a compact disc, may be read. As described in more detail below, audio content 52 (for example) and subcodes 54 may be provided as a result of reading content distribution 51. Audio 52 and subcodes 54 may then be processed by a software application 56, or any other suitable mechanism, such as dedicated hardware, a microprocessor executing firmware, etc. For example, in application 56, a watermark detector 53 may detect the watermarks in audio 52 and a subcode detector 55 may detect subcodes in subcodes 54. These detectors may then be used to determine whether the files are protected 37 or in-the-clear 38, and whether a watermark should be added 59. These determinations may be made as described below.

This embodiment may be used to detect watermarks and subcodes in a content distribution similar to the embodiments described in connection with FIGS. 1 and 2, but may also take the action of adding watermarks to certain content as described below in connection with table 60 of FIG. 6.

As shown in row 66, if the certain subcodes are detected (as indicated in column 61), but a watermark is not detected (as indicated in column 62), then the content may be allowed to be read into the application (as shown in column 63), a watermark may be added to the content (as shown in column 64), and protection may be applied (as shown column 65).

As shown in row 67, if the certain subcodes and no watermark are detected, then the content may be allowed to be read into the application (as shown in column 63), but a watermark may not be added to the content (as shown in column 64) and protection may not be applied (as shown in column 65).

As shown in row 68, if a watermark is detected, irrespective of whether subcodes are present, the content may be blocked from being read into the application (as shown in column 63).

As described above, rather than controlling transfer of content into an application, adding watermarks, and applying protection as illustrated in FIG. 6, additional or alternative access control actions may be used. For example, the following access controls may be used: whether and how hidden bits may be applied to content; whether and how content may be ripped to other media formats (e.g., ripping may be permitted at high quality or only low quality); whether and how addition benefits may be given; and/or any other suitable level(s) of access.

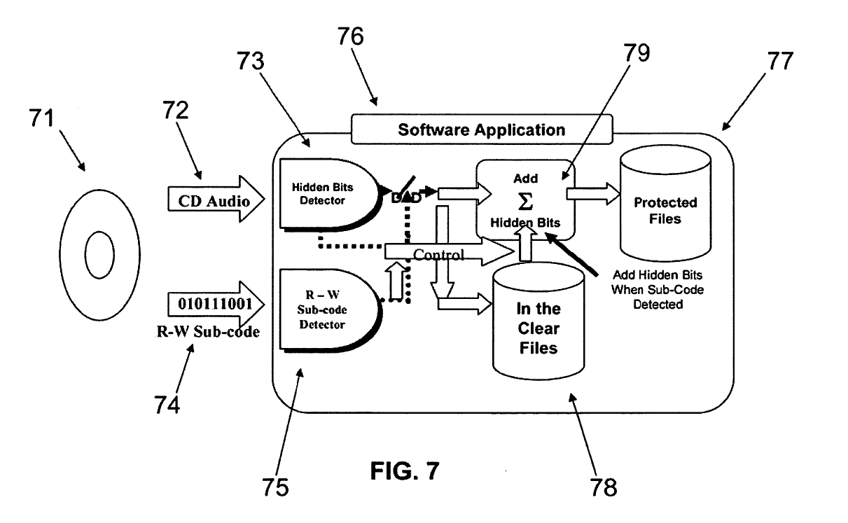

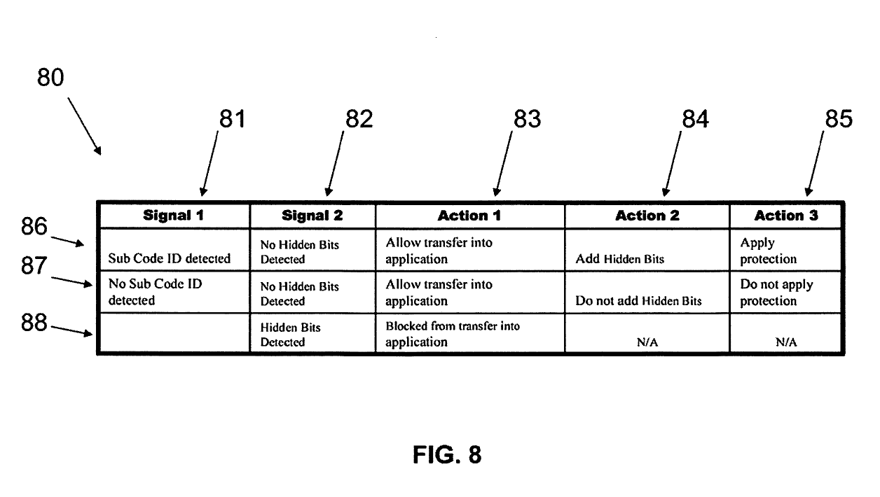

FIGS. 7 and 8 illustrate yet another approach that may be used in some embodiments.

As shown in FIG. 7, a content distribution 71, such as a compact disc, may be read. As described in more detail below, audio content 72 (for example) and subcodes 74 may be provided as a result of reading content distribution 71. Audio 72 and subcodes 74 may then be processed by a software application 76, or any other suitable mechanism, such as dedicated hardware, a microprocessor executing firmware, etc. For example, in application 76, a watermark detector 73 may detect the watermarks in audio 72 and a subcode detector 75 may detect subcodes in subcodes 74. These detectors may then be used to determine whether the files are protected 77 or in-the-clear 78, and whether a hidden bits should be added 79. These determinations may be made as described below.

As shown, hidden bits may be added to content, and used to control actions such as whether the content will be allowed to be transferred into an application and whether protection will be applied. For example, the hidden bits may be a RIFF Chunk, a QT Atom ID, or any other suitable data. This is described further below in connection with table 80 of FIG. 8.

As shown in row 86, if the certain subcodes are detected, but 110 hidden bits are detected, then the content may be allowed to be transferred into the application (as shown in column 83), hidden bits may be added (as shown in column 84), and protection may be applied (as shown in column 85).

As shown in row 87, if the certain subcodes and the hidden bits are not detected, then the content may be allowed to be transferred into the application (as shown in column 83), hidden bits may not be added (as shown in column 84), and protection may not be applied (as shown in column 85).

As shown in row 88, if hidden bits are detected, irrespective of whether the certain subcodes are detected, the content may be blocked from being transferred into the application (as shown in column 83).

As described above, rather than controlling transfer of content into an application, adding hidden bits, and applying protection as illustrated in FIG. 8, additional or alternative access control actions may be used. For example, the following access controls may be used: whether and how a watermark may be applied to content; whether and how content may be ripped to other media formats (e.g., ripping may be permitted at high quality or only low quality); whether and how addition benefits may be given; and/or any other suitable level(s) of access.

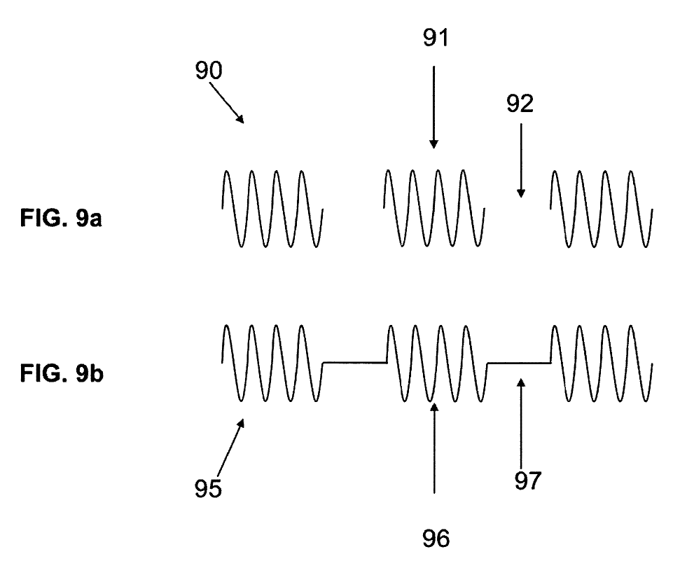

With reference to FIGS. 9A and 9B, some embodiments may emboss a wobble track on manufactured CDs or DVD and use that embossed wobble track to verify the authenticity of a CD or DVD.

As mentioned above, the wobble track is used to control operation of a recordable compact disc. More specifically, the general purpose of the wobble track is to provide an easily tracked signal to guide the write laser over the surface of un-recorded optical media. It does this by providing a steady state sine wave on the surface of the disc that is easily read by the read laser. This track is not present in manufactured, or pressed, media simply because it is not necessary. Even after recordable media has been recorded, the presence of the wobble track can still be detected through the use of SCSI Multi-Media Commands (MMCs).

In some embodiments, a wobble track can be embossed on a manufactured disc. In some embodiments, wobble tracks 90 and 95 can be caused to turn on and off (e.g., by having it be present in some parts 91 and 96 of the disc and not present in others 92 and 97) as shown in FIGS. 5A (where the off-state of the wobble is an absence of wobble 92) and 5B (where the-off state of the wobble is an embossed flat region 97). In this way, the wobble track can be pulse code modulated through the on-off blinking of the wobble track. This pulse code modulation can be used to embed a code (e.g., a numeric value) in the wobble track. This can be used, for example to determine the authenticity of the disc. In some embodiments, the rate that the wobble track can be blinked, or modulated, may be dependent on the rate at which the disc can be interrogated with MMCs. In some embodiments, the pulse code modulation may be applied to the table of contents portion of the wobble track on a CD (or the video title set of a DVD) so that the code is read early in the disc access process.

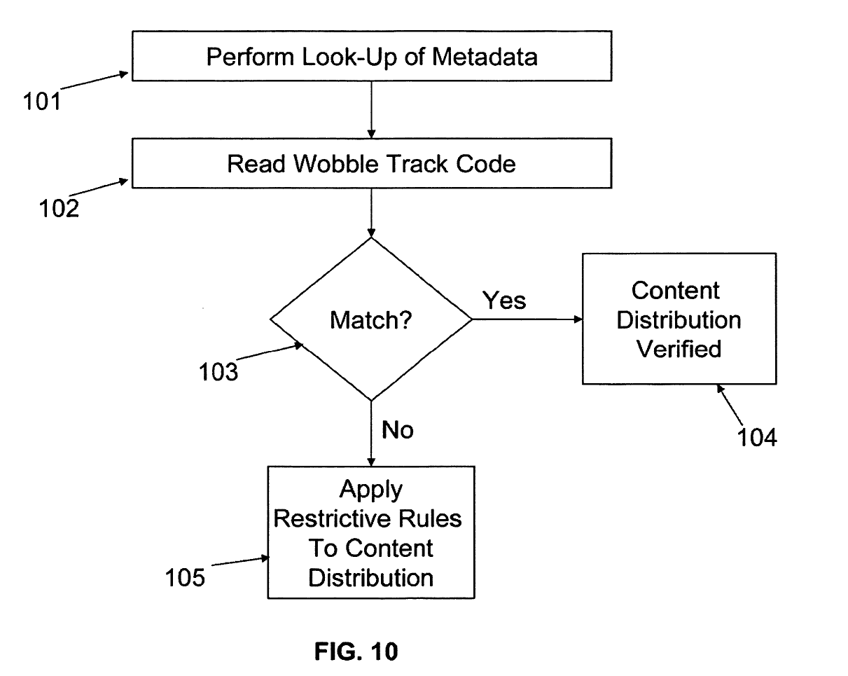

In some embodiments, a process for determining the authenticity of a disc can be performed as illustrated in FIG. 10. As shown, when a disc is inserted, a look-up process can be performed at 101 via the Internet or other suitable mechanism to obtain metadata (or other data) for that disc. For example, such data may be obtained from Gracenote-CDDB. The data returned may include album and track listings as well as a value that represents the “wobble track code” (or codes) that have been approved for that particular piece of media. In some embodiments, the code, or codes, can be different for CDs vs DVDs, and can be modified over time.

Next, at 102, the wobble track code can be read from the disc, as described above. Then, at 103, whether the “wobble track code” obtained from the disc matches the one received from the on-line service can be determined. Depending on whether the code matches, certain actions may be taken. For example, if the code does match, then the disc may be deemed “verified” as a manufactured product and appropriate usage rules applied (e.g., as described herein) at 104. If the code does not match, then the disc may be deemed a burned product and more restrictive rules are applied (e.g., as described herein) at 105. In some embodiments, the “matching” process at 103 may include using encryption or decryption on the two wobble track codes, or using only one or more certain portions of the embossed signal to generate the wobble track code.

In some embodiments, this process may be applied to all discs that are manufactured or only to some discs (e.g., new releases, catalog release, pre-releases, post-releases, and/or any other suitable releases).

In some embodiments, different actions may be taken when no on-line connection is available to authenticate the number found on the disc. For example, if there is no wobble track ID, then the disc may be treated as a burned disc. If there is a wobble track ID and no connection is available to verify that number, a third set of usage rules can be applied that gives the user some rights but not all “manufactured disc” rights (until an online verification can be made).

For example, until the disc can be verified, the user may be permitted to rip the CD into a library at a lower quality than would be permitted if the disc were verified. As a more particular example, in some embodiments, a dedicated, low-quality codec can be used to rip the CD into the library in such a scenario. Alternatively, a low-quality setting in a selectable on-demand adaptation mechanism for scalable media file rendering (such as an adaptive scalable perceptual audio coding, audio scalable lossless coding, or other suitable multi-rate and/or adaptive lossy and/or lossless coding, and associated codec) can be used to rip the CD into the library in such a scenario. The A-Star and MPG-4 SLS codecs are examples of adaptive codecs in which low-quality settings can be used, although any suitable codec can additionally or alternatively be used.

Although specific examples of different actions that may be taken have been described above and in connection with FIGS. 1-10, it should be apparent that any suitable action(s) can be taken in different embodiments. For example, in addition to, or alternatively to, restricting how a content distribution may be used (e.g., by controlling whether content will be allowed to be transferred into an application, by applying protection, by adding a watermark, by adding hidden bits, and/or by permitting ripping only at low qualities), actions giving benefits to holders of content distributions that have the appropriate combinations of watermark(s), subcode(s), wobble track, hidden bit(s), and/or wobble track code(s) may be performed. For example, an action giving a benefit may include providing additional content (e.g., bonus content) for a reduced fee or free and allowing content to be transferred to other devices (e.g., mobile devices) to users of content distributions that have the appropriate combinations of watermark(s), subcode(s), wobble track, hidden bit(s), and/or wobble track code(s). Other users may be prevented from accessing such additional content, or may be required to pay for such content.

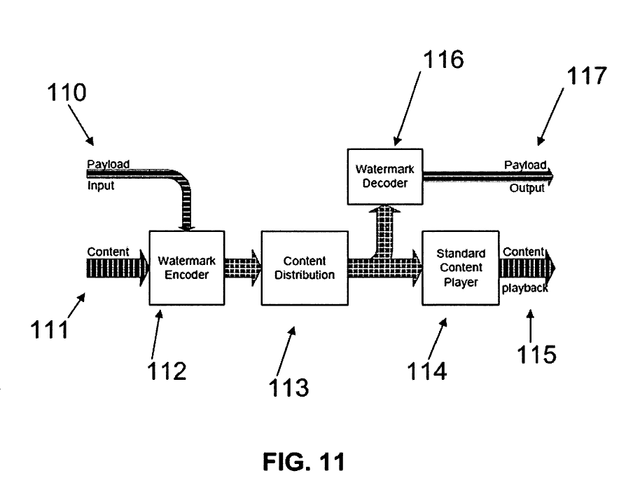

FIG. 11 illustrates a block diagram of a mechanism for encoding a watermark in content and then decoding the watermark from the content and playing-back the content in accordance with some embodiments. As shown, the content 111 and a payload 110 can be provided to a watermark encoder 112. The combined output of the watermark encoder can then be provided on a content distribution 113. As mention above, the content distribution may be, for example, a computer readable optical-medium defined as a compact disc in accordance with IEC 980, a High Definition DVD, a BlueRay disc, or any other suitable form of media. The content distribution may then be processed by a watermark decoder 116 to decode the payload 117 and a content player 114 to extract the content 115. The watermark decoder 116 and the content player 114 may be combined in some embodiments. The content player may be any suitable player, and may be a standard content player (as illustrated), or a non-standard content player.

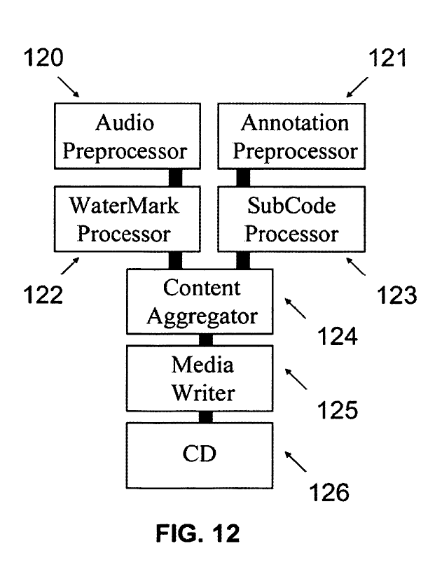

Referring to FIG. 12, a mechanism for producing a content distribution in accordance with some embodiments is illustrated. Although a compact disc (CD) is illustrated as being produced, it will be apparent that other forms of content distribution could additionally or alternatively be produced.

As shown, the content owner supplies audio content to an audio preprocessor 120. The in-process audio content enters a watermark processor 122, emerging as a digitally watermarked audio asset for manufacturing assembly by content aggregator 124. An annotation preprocessor 121 collects associative data for the in-process authentic audio content. The associative data may include any suitable data such as a content identifier, access constraints, rights, entitlements, etc. This data may be stored in a data structure by annotation preprocessor 121, and provided to a subcode processor 123, that prepares the data for embedding through an additional encoding by content aggregator 124. After sufficient content has been aggregated, media writer 125 writes the content to media 126.

As mentioned above, the certain subcodes may be written into subcodes R-W in a compact disc. Further details of this in accordance with some embodiments are now provided.

A compact disc contains one or more tracks recorded with digital audio data. Such tracks can be recorded in accordance with IEC Publication 908. An extended format CD-ROM can be of the type in which the information is recorded before delivery to the user and can only be read from the disk in accordance with ISO/IEC 10149, also known as ECMA-130.

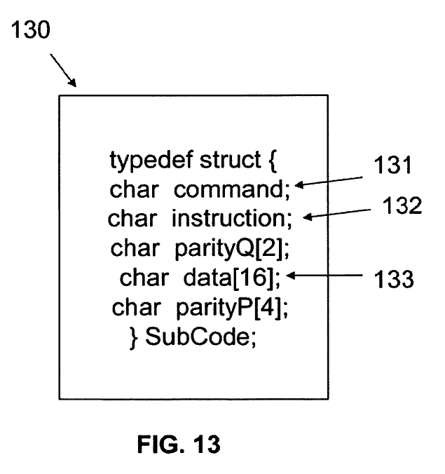

In optical media, two kinds of data exist: content data, which is used to store audio and computer software and the like; and subchannel data, which is normally used by a CD player to help control the disc. In optical media intended for CD use, within each disc sector there are 2352 bytes of content data and 96 bytes of subchannel data. The 96 bytes of subchannel data in each sector contain 4 packets of 24-bytes apiece. The structure of the packet can be as shown in 130 of FIG. 13.

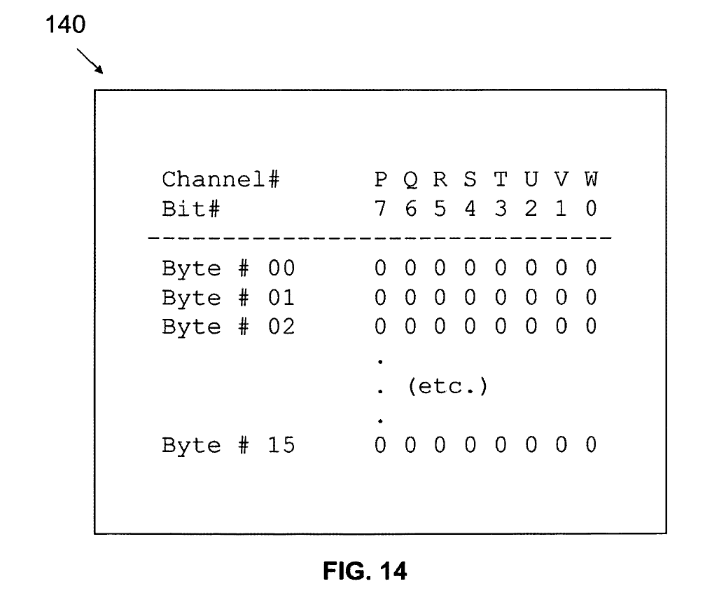

Each byte in the 16 byte SubCode.data[ ] field 133 can be logically structured within 8-bits. Each of these bits corresponds to a separate stream of information, and these streams are called “channels,” and can be labeled starting with the letter P with a resulting structure definition 140 as shown in FIG. 14

Both the P and Q channels, on a regular Audio CD, can be used for timing information, which is used to assist the CD Player in tracking the current location on the disc, and to provide the timing information for the time display on the CD Player. On a regular Audio CD, channels R through W can be unused, and may be used to store the certain subcodes. The certain subcodes can take any suitable form, and may be, for example, any non-zero values. The SubCode.command field 131 and the SubCode.instruction field 132 in each SubCode packet 130 may be used to determine how the data is to be interpreted.

An advantage to using the R-W subcodes is that these subcodes may not be used for the Table of Contents, and may not alter the performance of the disc in either single purpose audio players, or computer soft players.

As will be apparent to one of skill in the art, the present invention may be implemented in various forms as methods, media, and systems. For example, various embodiments can be implemented in computer systems. Those systems may include, for example, a content distribution reader (e.g., a compact disc drive), a processor for reading a processing content, watermarks, subcodes, wobble track, hidden bits, etc. from the content distribution, computer readable media (such as memory, disks, etc.) for containing computer instructions for performing the functions described herein, and any other suitable components.

Although the present invention has been described and illustrated in the foregoing illustrative embodiments, it is understood that the present disclosure has been made only by way of example, that numerous changes in the details of implementation of the invention may be made without departing from the spirit and scope of the invention, and that the scope of the invention is limited only by the claims which follow.

What is claimed is:

1. A method for access control to a content distribution, comprising:
detecting at least two of a subcode, a watermark, hidden bits, a wobble track, and a valid wobble track code in the content distribution;
determining whether the content distribution is an authorized product based on the detecting; and
performing an action based on whether the content distribution is determined to be an authorized product.

2. The method of claim 1 wherein the action comprises controlling a transfer of content from the content distribution into an application.

3. The method of claim 1 wherein the action comprises applying protection to content from the content distribution.

4. The method of claim 1 wherein the action comprises adding a watermark to content from the content distribution.

5. The method of claim 1 wherein the action comprises adding hidden bits to content from the content distribution.

6. The method of claim 1 wherein the action comprises degrading the quality level at which content from the content distribution can be ripped.

7. The method of claim 1 wherein the action comprises providing additional content.

8. The method of claim 1 wherein the action comprises transferring content from the content distribution to another device.

9. The method of claim 1 further comprising checking a wobble track code by looking-up an approved code and determining whether the wobble track code matches the approved code.

10. A computer-readable medium containing computer-executable instructions that, when executed by a processor, cause the processor to perform a method for access control to a content distribution, the method comprising:
detecting at least two of a subcode, a watermark, hidden bits, a wobble track, and a valid wobble track code in the content distribution;
determining whether the content distribution is an authorized product based on the detecting; and
performing an action based on whether the content distribution is determined to be an authorized product.

11. The medium of claim 10 wherein the action comprises controlling a transfer of content from the content distribution into an application.

12. The medium of claim 10 wherein the action comprises applying protection to content from the content distribution.

13. The medium of claim 10 wherein the action comprises adding a watermark to content from the content distribution.

14. The medium of claim 10 wherein the action comprises adding hidden bits to content from the content distribution.

15. The medium of claim 10 wherein the action comprises degrading the quality level at which content from the content distribution can be ripped.

16. The medium of claim 10 wherein the action comprises providing additional content.

17. The medium of claim 10 wherein the action comprises transferring content from the content distribution to another device.

18. The medium of claim 10 wherein the method further comprises checking a wobble track code by looking-up an approved code and determining whether the wobble track code matches the approved code.

19. A system for access control to a content distribution, comprising:
a processor that:
detects at least two of a subcode, a watermark, hidden bits, a wobble track, and a valid wobble track code in the content distribution;
determines whether the content distribution is an authorized product based on the detecting; and
performs an action based on whether the content distribution is determined to be an authorized product.

20. The system of claim 19 wherein the action comprises controlling a transfer of content from the content distribution into an application.

21. The system of claim 19 wherein the action comprises applying protection to content from the content distribution.

22. The system of claim 19 wherein the action comprises adding a watermark to content from the content distribution.

23. The system of claim 19 wherein the action comprises adding hidden bits to content from the content distribution.

24. The system of claim 19 wherein the action comprises degrading the quality level at which content from the content distribution can be ripped.

25. The system of claim 19 wherein the action comprises providing additional content.
